(19) United States
(12) Patent Application Publication
(10) Pub. No.: US 2005/0211829 A1
(43) Pub. Date: Sep. 29, 2005

(54) Magnetic Motive System

(76) Inventor: Morris M. Cohen, Bethesda, MD (US)

Correspondence Address: HOLME ROBERTS & OWEN, LLP, 299 SOUTH MAIN, SUITE 1800, SALT LAKE CITY, UT, 84111, US

(21) Appl. No.: 10/905,125

(22) Filed: Dec. 16, 2004

Related U.S. Application Data
(60) Provisional application No. 60/529,576, filed on Dec. 16, 2003.

(51) Int. Cl. H02P 9/04

(52) U.S. Cl. 244/62

(57) ABSTRACT

The invention is directed to a motive structure that, in one embodiment, is comprised of a body, a first magnetic field generator, a second magnetic field generator, and a controller for controlling the respective application of first and second currents to the first and second magnetic field generators such that there is a period of time during which: (a) said first current has terminated, (b) a first magnetic field resulting from the application of said first current to said first magnetic field generator means persists; (c) said second current is present, and (d) a second magnetic field resulting from the application of said second current to said second magnetic field generator means is present. During this period of time, the first magnetic field is decoupled from the body and, as such, provides a platform that at least one of the second current and the second magnetic field can interact so that a force is applied to the body.

### CROSS REFERENCE TO RELATED APPLICATIONS

This application claims the benefit of U.S. Provisional Application No. 60/529,576, filed Dec. 16, 2003, which is incorporated herein by reference in its entirety.

### FIELD OF THE INVENTION

The present invention is directed to a motive system that utilizes a magnetic field that persists after termination of the current which gave rise to the magnetic field as a platform relative to which a force can be produced to move the system.

### BACKGROUND OF THE INVENTION

Presently, magnetic fields are used to achieve motion in several different ways. For instance, magnetic fields are used in what are know as “maglev” trains to both levitate a train above a track and to propel the train along the track. In levitating a train, a magnetic field associated with the track cooperates with an oppositely directed magnetic field associated with the train to propel the train a certain distance above the track and substantially maintain the train at that distance above the track. Similarly, magnetic fields, one associated with the track and the other associated with the train, are used to propel the train along the track. Propulsion is achieved by appropriately switching the polarity of at least one of the two magnetic fields to produce, in conjunction with the other magnetic field, an attractive and/or repulsive force that pulls and/or pushes the train along the track. However, for both levitation above the track and propulsion along the track to be achieved, the track must be coupled to a very massive object, namely, the earth.

Magnetic fields are also used in electric motors to cause rotary motion. For example, a typical DC motor is comprised of a rotor that is located between two permanent magnets that are oriented to produce oppositely directed magnetic fields. The rotor is comprised of a coil and a pair of brushes that control the polarity of the current applied to the coil. In operation, the brushes and coil cooperate to produce a magnetic field that switches polarity every half turn of the rotor so that a repulsive force is applied to the rotor by one of the two permanent magnets associated with the stator and an attractive force is applied to the rotor by the other of the two permanent magnets associated with the stator. The repulsive and attractive forces applied to the rotor cause the rotor to rotate relative to the stator. It should be appreciated that, for the rotor to rotate, the stator must be substantially stationary.

Other magnetic propulsion systems involve the application of high velocity magnetic particles to a vehicle. In one such system, a space vehicle is provided that is capable of generating a magnetic bubble. The high velocity, ionized particles of the solar wind interact with the magnetic bubble to propel the vehicle. In another system, a space vehicle is provided with a magnetic sail. A high-speed magnetic particle beam produced by an earth station is directed to the magnetic sail of the vehicle to achieve the desired acceleration or deceleration of the vehicle. In both of these systems, propulsion of the vehicle is achieved because the sun and the earth station are very massive objects that remain substantially stationary.

### SUMMARY OF THE INVENTION

The present invention is directed to a magnetic motive system that utilizes a magnetic field that persists after termination of the current which gave rise to the magnetic field as a platform relative to which a force can be produced to move the system.

In one embodiment, the system comprises a body and two magnetic field generator devices that are each operatively attached to the body. Each of the magnetic field devices is capable of receiving a current and producing a magnetic field in response to the application of the current. The system further comprises a controller that, during operation, causes currents to be applied to each of the two magnetic field generators such that there is a period of time during which: (a) a current that had been applied to the first magnetic field generator has terminated, (b) a magnetic field resulting from the application of the current to the first magnetic field generator persists, (c) a current is being applied to the second magnetic field generator, and (d) a magnetic field resulting from the application of the current to the second magnetic field generator is present. Under these conditions, the magnetic field produced by the first magnetic field generator is decoupled from the body and the two magnetic field generators and, as such, is capable of functioning as a substantially stationary platform relative to which a force can be produced and applied to the body and the two magnetic field generators. The force is produced by the interaction of the persistent magnetic field with at least one of the currents applied to the second magnetic field generator and the magnetic field resulting from the application of the current to the second magnetic field generator.

The period of time during which the magnetic field persists is very short and dependent upon a number of factors. Further, the force that can be produced and applied to the body of the system during this period of time to may be limited. Consequently, in many applications, many of the noted periods of time must occur and these periods of time must occur with sufficient frequency in order for a sufficient force to be generated to achieve the desired effect (e.g., levitation or propulsion). In such applications, the frequency of the noted periods of time (hereinafter referred to as “the force-producing periods of time”) is in the Megahertz range or faster. In one embodiment of the system, this high frequency of the force producing periods of time is achieved by utilizing high-speed switches to selectively apply, under the direction of the controller, the currents to the two magnetic field generators. In another embodiment, the system comprises multiple pairs of magnetic field generators, which allow lower speed switches to be used. In this case, the controller phases the actuation of the switches associated with each pair of magnetic field generators to achieve the desired frequency of the force producing periods of time. It should be appreciated that in applications in which the system is to be propelled over a distance and multiple force producing periods are to be used to achieve the propulsion over the distance, the multiple magnetic field platforms that will be produced will move with the system. This is in contrast to magnetic propulsion systems that require a substantially stationary mass to work.

In many applications, the system must be capable of acceleration and deceleration. Consequently, the force produced by the system and applied to the system must be capable of being varied. For such applications, an embodiment of the system comprises a current generator that is capable of producing: (a) a first current that has a periodic waveform with a period and an amplitude that varies over the period, (b) a second current that also has a periodic waveform with a period and an amplitude that varies over the period, and (c) a phase relationship between the two waveforms of the two currents. To change the force produced during any force producing period, the controller is capable of directing the current generator to change or alter at least one, or a combination, of the period associated with the first current waveform, the period associated with the second current waveform, the amplitude associated with the first current waveform, the amplitude associated with the second current waveform, and the phase relationship of the two waveforms.

In yet another embodiment, the body of the system comprises a nacelle to which the first and second magnetic field generators are attached such that the generators are substantially stationary with respect to one another. In a further embodiment, the body further comprises a frame to which the nacelle is attached. For instance, in one application, the frame is a portion of an airplane airframe and the nacelle is attached to the portion of the airframe such that the nacelle is substantially stationary relative to the portion of the airframe. In another embodiment, the body further comprises an actuator that allows the nacelle and the frame to move relative to one another, thereby providing a vectored thrust capability during operation.

In a further embodiment of the system, the body comprises a frame and a control surface that is capable of moving relative to the frame and interacting with a fluid medium, such as air or water, to direct the system. One embodiment of the system employs a control surface that is useful in causing the body to rotate about one of a pitch axis, roll axis, and yaw axis. For example, the control surface may be a rudder of a ship, which is useful in causing the ship to rotate about a yaw axis.

In a further embodiment of the system, the body comprises a frame of a space vehicle. Alternatively, the body comprises the frame of a lifting vehicle that is useful in, for example, placing payloads in orbit. Alternatively, the body comprises the frame of a vehicle that is designed to move in two or more of water, air, and space.

In yet another embodiment, there are at least two pairs of magnetic field generators attached to a body. In one embodiment, the two pairs of magnetic field generators are attached to a body that has an axis of rotation such that the force that is generated by one or both of the generators can be used to rotate the body about the axis. A further embodiment uses the generators to force the body to move linearly.

### BRIEF DESCRIPTION OF THE DRAWINGS

FIG. 1 is block diagram of a first embodiment of a magnetic motive system;

FIGS. 2A-2D respectively illustrate examples of first and second current waveforms that are applied to the magnetic field generators shown in FIG. 1, the first current waveform and an associated magnetic field produced by the first magnetic field generator, the second current waveform and an associated magnetic field produced by the second magnetic field generator, and the superposition of the current and magnetic field waveforms of FIGS. 2B and 2C;

FIG. 3 illustrates a second embodiment of a magnetic motive system;

FIG. 4 illustrates an embodiment of a current generator that is useful in applications in which the magnetic motive system must produce a series of force pulses; and

FIG. 5 illustrates an embodiment of a magnetic motive system that uses two pairs of magnetic field generators.

### DETAILED DESCRIPTION

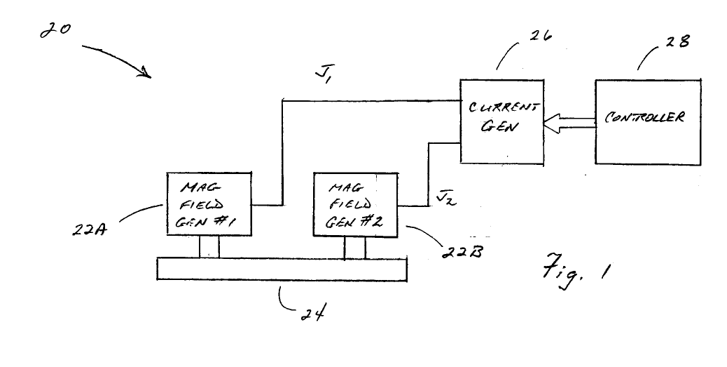

With reference to FIG. 1, an embodiment of a magnetic motive system 20 that utilizes a magnetic field that persists after termination of the current that gave rise to the magnetic field as a platform relative to which a force can be produced to move the system is described. The system 20 is comprised of a first and second magnetic field generators 22A, 22B that are each capable of receiving a current and, in response to the current, generating a magnetic field. The first and second magnetic field generators 22A, 22B, are each operatively attached to a body 24 such that the generators are substantially stationary relative to one another. The system 20 further comprises a current generator 26 that is capable of generating the currents J1, J2, that are respectively applied to the first and second magnetic field generators 22A, 22B. It should be appreciated that the current generator 26 may be comprised of multiple current generators. Further, when multiple current generators are utilized, one current generator may be associated with one magnetic field generator. The system 20 further comprises a controller 28 for directing the application of the currents J1, J2, to the first and second magnetic field generators 22A, 22B.

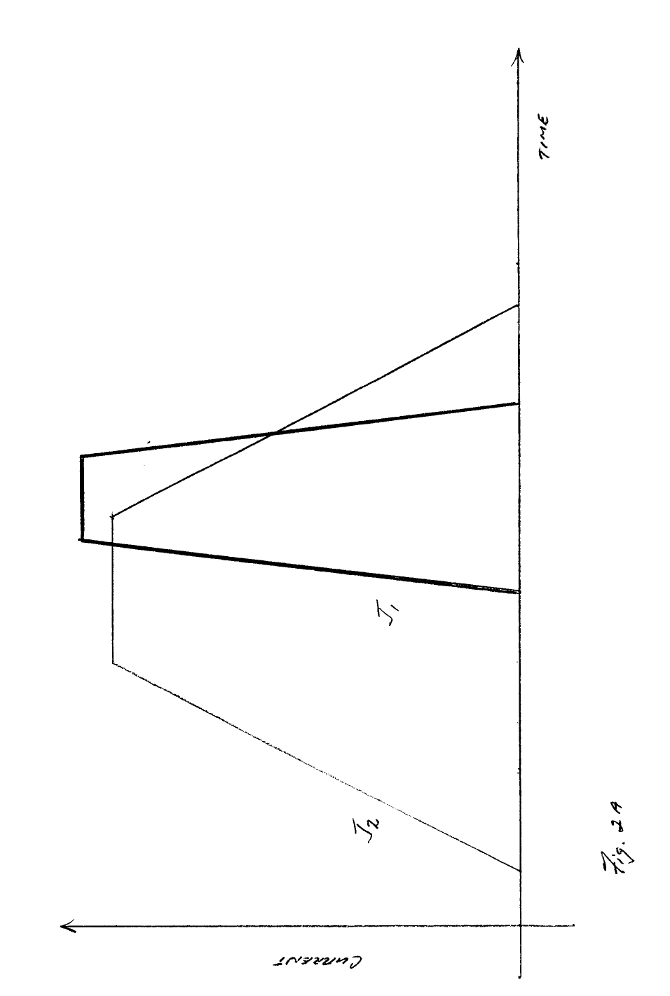

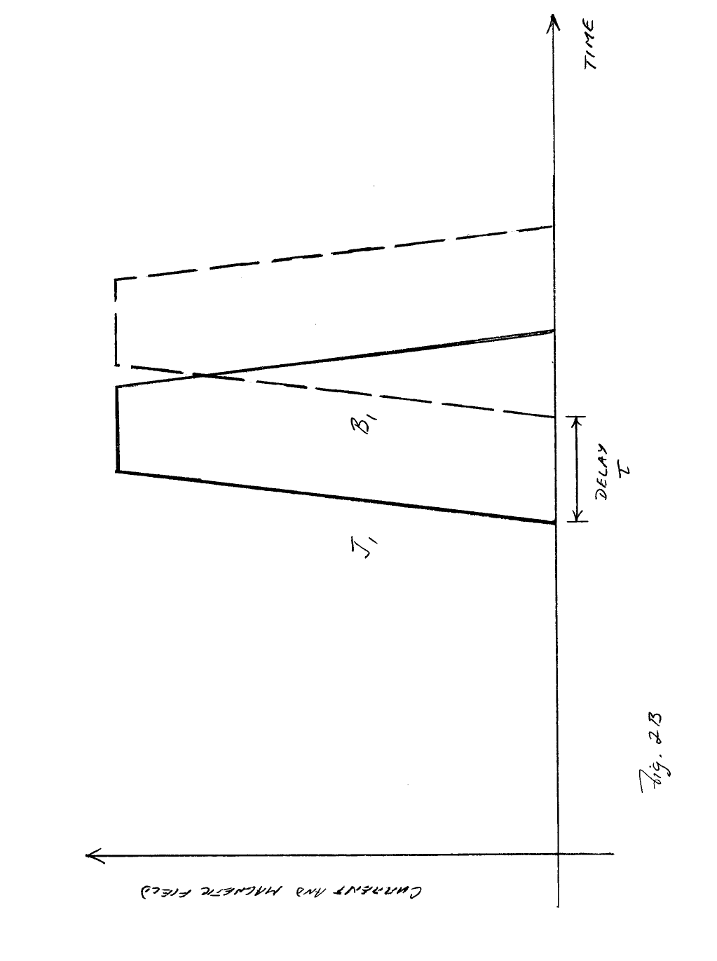

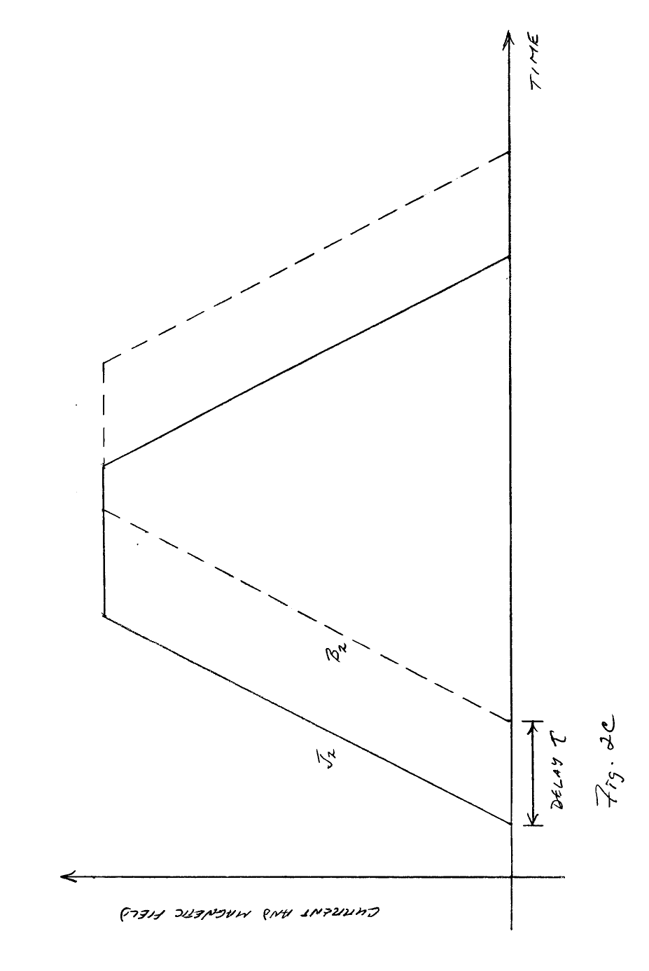

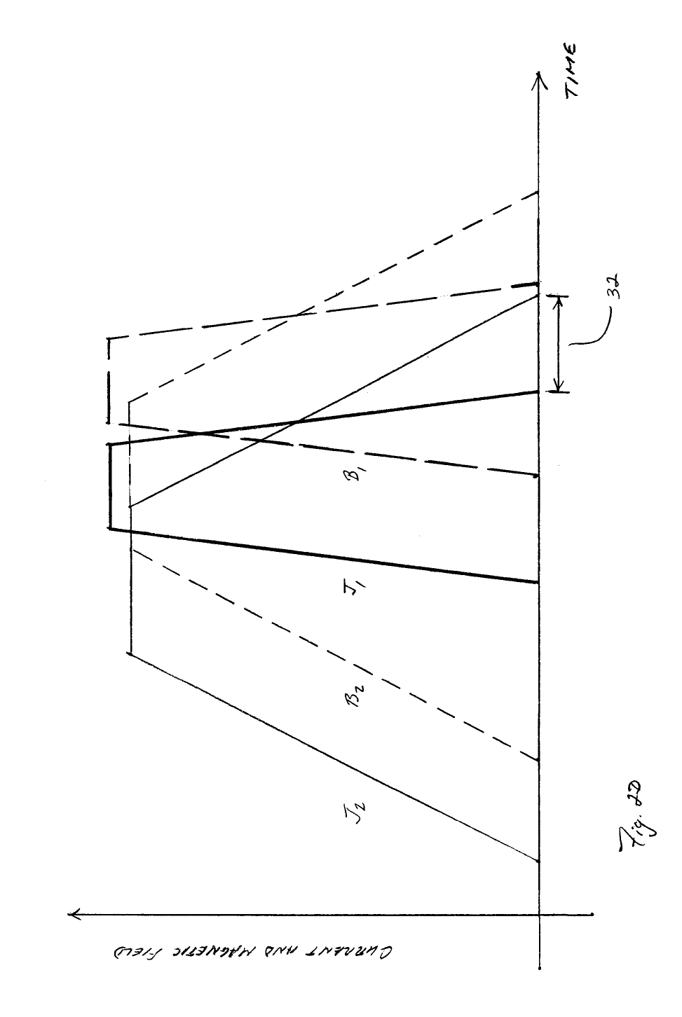

With reference to FIGS. 2A-2D, operation of the system 20 comprises the controller 28 directing the current generator to produce the currents J1 and J2 that are respectively applied to the first and second magnetic field generators 22A, 22B. The currents J1 and J2 can each be characterized as having pulsed current waveforms, i.e., having a period of time when the current increases from substantially zero amperes to a maximum amperage and then returns to zero amperes (i.e., the pulse) with periods of time immediately preceding and following the pulse in which the current is substantially zero amperes (i.e., the current is terminated).

With reference to FIG. 2B, the first magnetic field generator 22A produces a magnetic field B1 in response to the current J1. However, there is a time delay between the application of the current J1 and the production of the corresponding magnetic field B1 at a point separated from the wire. This delay is due to the finite speed at which electromagnetic waves propagate through a vacuum or through a medium, such as air or water. Consequently, there is a delay between the time that the pulse associated with the current J1 is applied to the first magnetic field generator 22A and the time that the corresponding pulse in the magnetic field B1 is produced at a point separated from the wire.

With reference to FIG. 2C, the second magnetic field generator 22B produces a magnetic field B2 in response to the current J2. However, there is also a time delay between the application of the current J2 and the production of the corresponding magnetic field B2. Consequently, there is a delay between the time that the pulse associated with the current J2 is applied to the first magnetic field generator 22B and the time that the corresponding pulse in the magnetic field B1 is produced.

With reference to FIG. 2D, the controller 28 causes the currents J1, J2, and, more specifically, the pulses associated with these currents to be applied to the first and second magnetic field generators 22A, 22B, such that there is a period of time 32 during which the current J1 has terminated but the magnetic field B1 that corresponds to the prior pulse of the current J1 persists. This magnetic field B1 serves as a platform relative to which a force is produced that is applied to the body 24 and the first and second magnetic field generators 22A, 22B. The force is a result of the interaction of the magnetic field B1 with at least one of the current J2 and the magnetic field B2 present during the period of time 32. The period of time 32 is hereinafter referred to as the force-producing period of time 32.

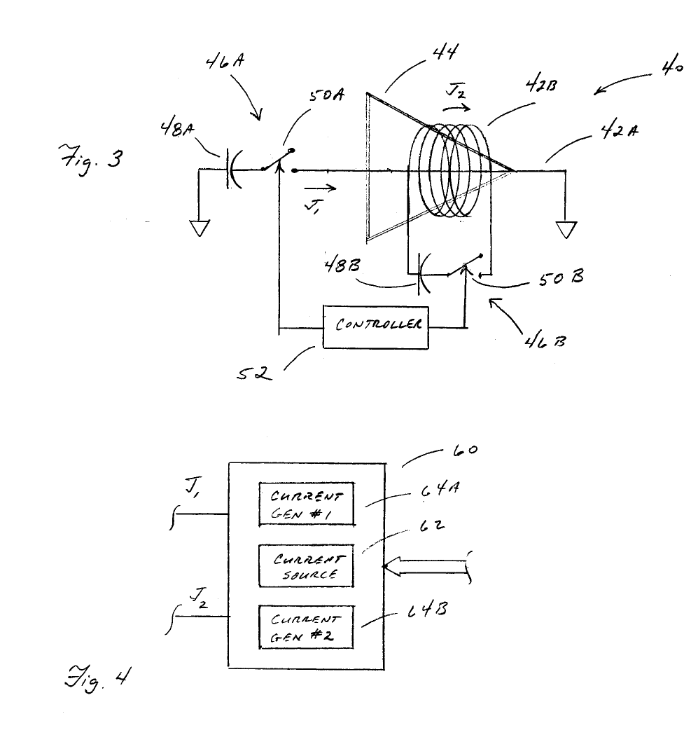

With reference to FIG. 3, a particular embodiment of a magnetic motive system 40 is described. The system 40 is comprised of a linear conductor 42A that is capable of receiving a current and generating a magnetic field in response thereto. The system also comprises a coil 42B that is also capable of receive a current and generating a magnetic field in response thereto. The linear conductor 42A and the coil 42B are each attached to a body in the form of a vehicle 44 such that the linear conductor 42A and the coil 42B are substantially stationary relative to one another. Moreover, a portion of the linear conductor 42A passes through the volume enclosed by the coil 42B.

The system 40 is further comprised of: (a) a first current generator 46A for generating a current J1 that is applied to the linear conductor 42A, and (b) a second current generator 46B for generating a current J2 that is applied to the coil 42B. The first current generator 46A is comprised of a first capacitor 48A and a switch 50A. Similarly, the second current generator is comprised of a second capacitor 48B and a switch 50B. A controller 52 controls the state (on/off) of switches 50A and 50B.

Assuming that the first and second capacitors 48A, 48B, are each charged and the switches 50A, 50B, are each in an off state, the controller 52 actuates the switches 50A, 50B, in a manner that results in current pulses respectively flowing through the linear conductor 42A and the coil 42B. The controller 52 times the actuation of the switches 50A, 50B such that there is a period of time when the current J1 in the linear conductor 42A has terminated, the time-delayed magnetic field B1 corresponding to the current pulse of current J1 persists, the current pulse of current J2 is still present in the coil 42B, and the time-delayed magnetic field B2 corresponding to the current pulse of current J2 is present. The persisting time-delayed magnetic field B1 serves as a platform relative to which a force can be produced and applied to the vehicle 44. The force results from the interaction of the persisting time-delayed magnetic field B1 and at least one of the current pulse in the coil 42B and the time-delayed magnetic field corresponding to the current pulse in the coil 42B.

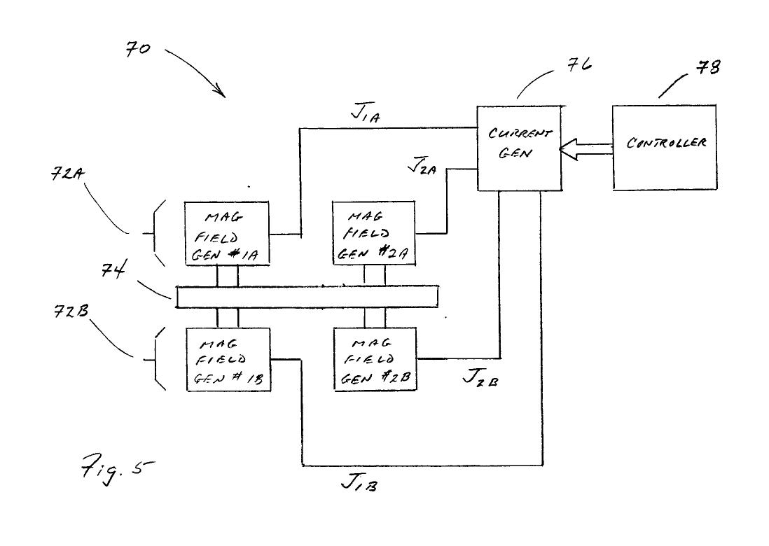

In many applications, more than one force generating period of time will be required because a single force-generating period of time (typically, on the order of microseconds or nanoseconds in duration) produces insufficient force over the period of time needed for the body to reach a destination within a desired time. For example, if the body 24 of the system 20 comprises an airplane airframe and the airplane is flying from point A to point B, air drag must be overcome for substantially the entire flight between points A and B. With reference to FIG. 4, an embodiment of the current generator 60 that is suitable for use in generating multiple force generating periods of time is comprised of a current source 62 and first and second current generators 64A, 64B. In operation, the current source 62 provides current to the first and second current generators 64A, 64B. The first and second current generators 64A, 64B respectively provide currents with periodic waveforms to the first and second magnetic field generators (e.g., the current waveforms of the currents J1 and J2 shown in FIG. 2A could be repeated to produce period current waveforms). This, in turn, results in a periodic train of force pulses applied to the body with which the magnetic field generators are associated. For example, currents with the periodic waveforms could be provided to the first and second magnetic field generators 22A, 22B. In turn, the first and second magnetic field generators 22A, 22B, would produce and apply a periodic train of force pulses to the body 24. It should be appreciated that the current source 60 can take any number of forms, including but not limited to a nuclear reactor, a battery, a fuel cell, a solar cell, a steam generator, a turbine generator, a combustion engine, or combinations thereof. Further, the current generators 64A, 64B can also take any number of forms. For instance, a current generator could each be comprised of a capacitor and switch (as shown in FIG. 3) or be a device that is capable of producing two current waveforms with particular characteristics (amplitude, rise time, fall time etc.) or be a device that is capable of producing two current waveforms with the characteristics of at least one of the current waveforms being alterable by the controller.

In many applications, the force that must be applied to a body must be varied over time. For example, if the body 24 of the system 20 comprises an automobile frame, a greater force must be applied to overcome the mass of the automobile when the automobile is at a standstill on the ground than will be required to maintain the automobile at a constant speed when on a horizontal roadway. For such applications, a controller is provided that is able to provide the current generator with a signal or signals concerning the increasing and/or decreasing of the force applied to the body. Relatedly, the current generator must be able to process such a signal or signals. The current generators provide the capability of processing such a signal or signals by providing the ability to: (a) alter the period of one of the current waveforms, (b) alter the period of both of the current waveforms, (c) alter the amplitude profile of one of the current waveforms, (d) alter the amplitude profile of both current waveforms, (e) change the relative phase relationship of the two current waveforms, (f) change the direction of current flow of one of the currents, (g) change the direction of current flow of both of the currents, or (g) provide a combination of two or more of these abilities. For example, the controller 28 of the system 20 would be capable of providing a signal or signals to the current generator 26 concerning the need to increase and/or decrease the force applied to the body 24. The current generator 24 could be implemented in the form of the current generator 60 with the first and second current generators being adapted as needed to implement one or a combination of the noted abilities to alter the current waveforms.

In certain applications, a single pair of magnetic field generators is not capable of being used to either: (a) generate a sufficient force within a single force producing period of time, or (b) generate enough force producing periods over time. For such applications, a magnetic motive system is provided that utilizes multiple pairs of magnetic field generators, each pair being capable of operating to produce one or a series of force producing periods. Further, the system utilizes a controller and a current generator that provide the pairs of magnetic field generators with the current waveforms needed to produce the desired force profile. For example, the controller and current generator may operate so as to provide substantially identical current waveforms to both of the pairs of magnetic field generators. In this case, assuming the magnetic field generators are substantially identical to one another, each pair of magnetic field generators would produce substantially the same force over the same period of time. Consequently, the force applied to the body is twice the force that one pair of magnetic field generators could produce. Alternatively, the controller and generator may operate to provide current waveforms to the both of the pairs of magnetic field generators that are phased so that a force producing period produced using one of the pairs of magnetic field generators is shifted in time relative to the force producing period produced using the other of the pairs of magnetic field generators.

With reference to FIG. 5, an embodiment of a magnetic motive system 70 that employs two pairs of magnetic field generators is described. The system 70 is comprised of a first pair of magnetic field generators 72A and a second pair of magnetic field generators 72B. The first and second pairs of magnetic field generators 72A, 72B, are each attached to a body 74 such that each pair of magnetic field generators are substantially stationary relative to the other pair of magnetic field generators. Moreover, the magnetic field generators of each pair of magnetic field generators are substantially stationary relative to one another. A current generator 76 provides a first pair of currents J1A, J2A to the first pair of magnetic field generators 72A and a second pair of currents J1B, J2B to the second pair of magnetic field generators 72B. The system 70 further comprises a controller 78 that directs the applications of the two pairs of currents to the first and second pairs of magnetic field generators 72A, 72B.

In operation, the current generator 76 and controller 78 cooperate to cause the two pairs of currents to be applied to the two pairs of magnetic field generators 72A, 72B, such that a desired force profile is achieved. For example, substantially identical pairs of currents may be applied to the two pairs of magnetic field generators 72A, 72B, such that one of said pairs of magnetic field generators has one or more force producing periods of time that substantially coincide with one or more force producing periods associated with the other of the pair of magnetic field generators. Alternatively, pairs of currents may be applied to the two pairs of magnetic field generators 72A, 72B, such that one of the pairs of magnetic field generators has one or more force producing periods that are time or phase shifted relative to one or more force producing periods associated with the other of the pair of magnetic field generators.

The body to which a pair of magnetic field generators is attached can take many forms. For example, with reference to FIG. 1, the body 24 to which the pair of magnetic field generators 22A, 22B, is attached can take numerous forms. For example, the body 24 may comprise a housing that is capable of being mounted to a vehicle. Such a housing may, for example, take the form of a nacelle that is suitable for mounting to an aircraft airframe. The body 24 may comprise a housing and a frame of a vehicle to which the housing is attached. In addition the body 24 may comprise a housing, a frame of a vehicle, and an actuator that allows the housing and frame to move relative to one another. Such a body would provide the ability to direct the movement of a vehicle by vectoring the thrust produced by the operation of the pair of magnetic field generators. The body 24 may be a portion of the frame of a vehicle that employs steerage structure. For example, the body 24 may be a portion of the frame of a vehicle that employs a control surface that interacts with a fluid medium to steer the vehicle. Examples of such vehicles are airplanes, ships, and submarines. Typically, airplanes employ control surfaces such as ailerons, elevators, and rudders to selectively and respectively produce rotation about the roll axis, pitch axis and yaw axis of the airplane. Ships and submarines typically employ a rudder to produce rotation about a yaw axis of the ship or submarine. Submarines also typically employ one or more planes (e.g., bow planes, mid-ships planes, and stern planes) for selectively producing rotation about a roll axis of the submarine. The body 24 may also be a portion of a frame of a vehicle that has a wheel that rotates relative to the frame, such as an automobile. The body 24 may also comprises a frame of a space vehicle. Additionally, the body 24 may comprise the frame of a lifting vehicle that is useful in, for example, placing payloads in orbit. Further, the body 24 may comprise the frame of a vehicle that is designed to move in two or more of water, air (e.g., on land and/or above the earth's surface), and outer space.

In embodiments of the system that employ two or more pairs of magnetic field generators, the magnetic field generators can be attached to the body so that the body can be steered or have its attitude altered. For example, in one embodiment, the body has an axis about which rotation is desired (e.g., a roll axis, pitch axis, and yaw axis), the magnetic field generators are positioned so as to be able to produce forces that result in rotation of the body about the axis. In another embodiment, the two pairs of magnetic field generators are attached to the body and moveable, via one or more actuators, relative to the body. In this embodiment, the two pairs of magnetic field generators are capable of being used to produce rotation about two or more axes. In yet a further embodiment, two pairs of magnetic field generators are attached to the body and controlled such that the force of one or both of the pairs of the magnetic field generators is variable, thereby allowing the generators to be used to steer the body.

The embodiments described hereinabove are intended to describe the best mode known of practicing the invention and to enable others skilled in the art to utilize the invention.

1. A motive structure comprising:
a body;
a first magnetic field generator means;
a second magnetic field generator means;
wherein said first and second magnetic field generator means are each operatively attached to said body;
a controller for, during operation, controlling the application of a first current to said first magnetic field generator means and a second current to said second magnetic field generator means such that there is a period of time during which: (a) said first current has terminated, (b) a first magnetic field resulting from the application of said first current to said first magnetic field generator means persists; (c) said second current is present, and (d) a second magnetic field resulting from the application of said second current to said second magnetic field generator means is present;
wherein, during said period of time, said first magnetic field is decoupled from said body, said first magnetic field generator means, and said second magnetic field generator means, and provides a platform with respect to which at least one of said second current and said second magnetic field can interact so that a force is applied to said body, said first magnetic field generator means, and said second magnetic field generator means.

2. A motive structure, as claimed in claim 1, wherein:
said body comprises a nacelle to which said first and second magnetic field generator means are each operatively attached such that said first and second magnetic field generator means are stationary relative to one another.

3. A motive structure, as claimed in claim 2, wherein:
said body comprises a frame that is operatively connected to said nacelle.

4. A motive structure, as claimed in claim 3, wherein:
said body comprises an actuator for use in causing said nacelle and said frame to move relative to one another.

5. A motive structure, as claimed in claim 1, wherein:
said body comprises a steerage structure and a frame.

6. A motive structure, as claimed in claim 5, wherein:
said steerage structure comprises a control surface structure that is capable of moving relative to said frame and interacting with a fluid medium to apply a force to said frame.

7. A motive structure, as claimed in claim 6, wherein:
said body has at least one of a pitch axis, roll axis, and yaw axis; and
said control surface structure comprises at least one of: a pitch control surface for use in applying a force to said frame to cause said body to rotate about said pitch axis, a roll control surface for use in applying a force to said frame to cause said body to rotate about said roll axis, and a yaw control surface for use in applying a force to said frame to cause said body to roates about said yaw axis.

8. A motive structure, as claimed in claim 6, wherein:
said control surface structure comprises one of: a aileron, a spoiler, an elevator, a stabilator, and a rudder.

9. A motive structure, as claimed in claim 6, wherein:
said control surface structure comprises one of: rudder, bow plane, stern plane, and mid-ships plane.

10. A motive structure, as claimed in claim 9, wherein:
said body comprises a ballast tank.

11. A motive structure, as claimed in claim 1, wherein:
said body comprises a frame and a wheel that is capable of rotating relative to said frame.

12. A motive structure, as claimed in claim 1, wherein:
said first magnetic field generator means and said second magnetic field generator means are stationary relative to one another.

13. A motive structure, as claimed in claim 1, wherein:
said controller, during operation, is capable of changing the direction of said second current to change the direction of said force that is applied to said body, said first magnetic field generator means, and said second magnetic field generator means.

14. A motive structure, as claimed in claim 1, wherein:
said first magnetic field generator means comprises a linear conductor.

15. A motive structure, as claimed in claim 1, wherein:
said second magnetic field generator means comprises a coil.

16. A motive structure, as claimed in claim 1, wherein:
said first magnetic field generator means comprises a linear conductor;
said second magnetic field generator means comprises a coil that encloses a volume; and
at least a portion of said linear conductor is located within said volume.

17. A motive structure, as claimed in claim 1, wherein:
said first magnetic field generator means comprises a linear conductor;
said second magnetic field generator means comprises a coil with a longitudinal axis; and
wherein said coil defines a volume that extends along said longitudinal axis;
wherein at least a portion of said linear conductor is located within said volume.

18. A motive structure comprising:
a body;
a first magnetic field generator means;
a second magnetic field generator means;
wherein said first magnetic field generator and said second magnetic field generator means are each operatively attached to said body;
a current generator for, during operation, producing: (a) a first current that has a first periodic waveform with a first period and a first varying amplitude, (b) a second current that has a second periodic waveform with a second period and a second varying amplitude, (c) and a phase relationship between said first and second periodic waveforms;
a controller for, during operation, controlling said current generator so that said first current is applied to said first magnetic field generator means and said second current is applied to said second magnetic field generator means such that there are periods of time during which: (a) said first current has terminated, (b) a first magnetic field resulting from the application of said first current to said first magnetic field generator means persists; (c) said second current is present, and (d) a second magnetic field resulting from the application of said second current to said second magnetic field generator means is present;
wherein, during said periods of time, said first magnetic field is decoupled from said body, said first magnetic field generator means, and said second magnetic field generator means, and provides a platform with respect to which at least one of said second current and said second magnetic field can interact so that a force is applied to said body, said first magnetic field generator means, and said second magnetic field generator means.

19. A motive structure, as claimed in claim 18, wherein:
said controller is capable, during operation, of changing at least one of said first period of said first current waveform and said second period of said second current waveform.

20. A motive structure, as claimed in claim 18, wherein:
said controller is capable, during operation, of changing said first period of said first current waveform and said second period of said second current waveform.

21. A motive structure, as claimed in claim 18, wherein:
if said first current waveform has a substantially non-zero current sub-period and a substantially zero current sub-period, said controller is capable of changing at least one of said substantially non-zero current sub-period and said substantially zero current sub-period.

22. A motive structure, as claimed in claim 18, wherein:
if said second current waveform has a substantially non-zero current sub-period and a substantially zero current sub-period, said controller is capable of changing at least one of said substantially non-zero current sub-period and said substantially non-zero current sub-period.

23. A motive structure, as claimed in claim 18, wherein:
said controller is capable of changing at least one of said first varying amplitude and said second varying amplitude.

24. A motive structure, as claimed in claim 18, wherein:
said controller is capable of changing said first varying amplitude and said second varying amplitude.

25. A motive structure, as claimed in claim 18, wherein:
said controller is capable of changing said phase relationship of first and second periodic waveforms.

26. A motive structure, as claimed in claim 18, wherein:
said first period is less than about a microsecond.

27. A motive structure, as claimed in claim 18, wherein:
said current generator comprises a nuclear reactor.

28. A motive structure, as claimed in claim 18, wherein:
said current generator comprises a battery.

29. A motive structure, as claimed in claim 18, wherein:
said current generator comprises a fuel cell.

30. A motive structure, as claimed in claim 18, wherein:
said current generator comprises a solar cell.

31. A motive structure, as claimed in claim 18, wherein:
said current generator comprises a turbine.

32. A motive structure, as claimed in claim 18, wherein:
said current generator comprises a combustion engine.

33. A motive structure comprising:
a body;
a first pair of magnetic field generators that are each operatively attached to said body and stationary relative to one another;
a second pair of magnetic field generators that are each operatively attached to said body and stationary relative to one another;
a controller for, during operation, causing:
a first pair of currents to be applied to said first pair of magnetic field generators such that such that there is a first period of time during which one of said first pair of currents but not an associated magnetic field has terminated and the other of said first pair of currents and an associated magnetic field have not terminated; and
a second pair of currents to be applied to said second pair of magnetic field generators such that there is a second period of time during which one of said second pair of currents but not an associated magnetic field has terminated and the other of said second pair of currents and an associated magnetic field have not terminated.

34. A motive structure, as claimed in claim 33, wherein:
said controller is capable, during operation, of changing a time difference between said first period of time and said second period of time.

35. A motive structure, as claimed in claim 33, wherein:
said body having at least one of a pitch axis, a roll axis, and a yaw axis; and
said first and second pairs of magnetic field generators each oriented for producing rotation of said body about one of said pitch axis, said roll axis, and said yaw axis.

36. A motive structure, as claimed in claim 33, wherein:
said body having at least one of a pitch axis, a roll axis, and a yaw axis; and
said first and second pairs of magnetic field generators each capable of being oriented for producing rotation of said body about one of said pitch axis, said roll axis, and said yaw axis.

37. A motive structure, as claimed in claim 33, wherein:
said body having at least two of a pitch axis, a roll axis, and a yaw axis; and
said first and second pairs of magnetic field generators are each oriented to lie in a plane defined by two of said roll axis, said pitch axis and said yaw axis.

38. A motive structure, as claimed in claim 37, wherein:
said first and second pairs of magnetic field generators are oriented such that a force produced by each is substantially parallel to one of said two axes that define said plane.

39. A motive structure, as claimed in claim 33, wherein:
said first and second pairs of magnetic field generators are oriented such that a force that a force produced by one is substantially parallel to one of said two axes that define said plane but substantially opposite to a force produced by the other.
